(19) United States
(12) Patent Application Publication
(10) Pub. No.: US 2024/0206366 A1
(43) Pub. Date: Jun. 27, 2024

(54) SYSTEM AND METHOD FOR MONITORING OPERATING CONDITIONS FOR DYNAMIC CONTROL OF AN AGRICULTURAL IMPLEMENT

(71) Applicant: CNH Industrial Canada, Ltd., Saskatoon (CA)

(72) Inventors: Trevor Lawrence Kowalchuk, Saskatoon (CA); Nicholas George Alfred Ryder, Saskatoon (CA)

(21) Appl. No.: 18/101,266

(22) Filed: Jan. 25, 2023

Related U.S. Application Data
(60) Provisional application No. 63/435,463, filed on Dec. 27, 2022.

(51) Int. Cl. A01B 79/00

(52) U.S. Cl. CPC A01B 79/005

(57) ABSTRACT

An agricultural system includes an agricultural implement comprising a plurality of ground engagement tools, wherein each ground engagement tool of the plurality of ground engagement tools is configured to engage soil of a field. Additionally, the agricultural system includes a controller with a memory and a processor, wherein the controller is configured to receive a signal indicative of a speed of a rotational element of the agricultural implement, determine that a difference between the speed of the rotational element and an expected speed of the rotational element of the agricultural implement is greater than a threshold, wherein the expected speed of the rotational element is associated with a no-slip operating condition of the agricultural implement, and reduce an engagement between at least one ground engagement tool of the plurality of ground engagement tools and the soil in response to the difference being greater than the threshold.

### CROSS-REFERENCE TO RELATED APPLICATION

This application claims priority to and the benefit of U.S. Provisional Application No. 63/435,463, entitled “SYSTEM AND METHOD FOR MONITORING OPERATING CONDITIONS FOR DYNAMIC CONTROL OF AN AGRICULTURAL IMPLEMENT,” filed Dec. 27, 2022, which is hereby incorporated by reference in its entirety.

### BACKGROUND

The disclosure relates generally to an agricultural system and, more specifically, to a system and a method for monitoring operating conditions for dynamic control of an agricultural implement.

This section is intended to introduce the reader to various aspects of art that may be related to various aspects of the present disclosure, and are described below. This discussion is believed to be helpful in providing the reader with background information to facilitate a better understanding of the various aspects of the present disclosure. Accordingly, it should be noted that these statements are to be read in this light, and not as admissions of prior art.

Agricultural systems are used to farm a field, and a particular agricultural system may include a work vehicle and an agricultural implement towed behind the work vehicle. The agricultural implement may perform an agricultural operation, such as tilling, planting, seeding, and so forth, and the work vehicle may move across a field to drive the agricultural implement across the field. The work vehicle and the agricultural implement may have different sets of wheels to enable traversal of the field. In addition, certain agricultural implements may include ground engaging tools configured to interact with soil. For example, a seeding implement and/or a planting implement may include disc openers configured to form trenches in the soil, and to deliver seeds, fertilizer, other product(s), or a combination thereof, into the trenches. Furthermore, certain implements include a depth adjustment mechanism configured to control a penetration depth of one or more respective ground engaging tools into the soil. For example, certain agricultural implements may include a turnbuckle extending between a hitch assembly and a frame of the implement. The turnbuckle may be adjusted to set the height of the frame relative to the surface of the soil, thereby setting the penetration depth of the ground engaging tools to a target penetration depth. Additionally or alternatively, ground engaging tools of an agricultural implement (e.g., a seeding implement, a planting implement) may be independently adjusted to set a penetration depth relative to the soil surface.

However, during operation, moving the ground engaging tool(s) through the field may cause a draft load and/or a draft force on the work vehicle in a direction opposite a direction of travel. The draft load may depend at least in part on the penetration depth of the ground engaging tool(s) relative to the soil surface. For example, increasing the penetration depth of a ground engaging tool may increase the draft load on the work vehicle, and vice versa. Furthermore, the draft load may be affected by operating conditions of the field, such as moisture content of the soil, and operating conditions of the agricultural implement, such as conditions that may increase weight of the agricultural implement. In some instances, the draft load (e.g., draft force) may be high enough to cause the work vehicle wheels and/or tracks to experience slippage relative to the surface of the soil. In particular, the wheels and/or tracks of the work vehicle may move at a different speed (e.g., a higher linear speed) than a ground speed of the work vehicle (e.g., the agricultural system). In some instances, the draft load may cause the work vehicle (e.g., the agricultural system) to stop forward motion all together, or in other words, the work vehicle (e.g., the agricultural system) may become stuck in the soil (e.g., the wheel(s) and/or track(s) may dig into the soil surface).

### BRIEF DESCRIPTION

A summary of certain embodiments disclosed herein is set forth below. It should be noted that these aspects are presented merely to provide the reader with a brief summary of these certain embodiments and that these aspects are not intended to limit the scope of this disclosure. Indeed, this disclosure may encompass a variety of aspects that may not be set forth below.

In certain embodiments, an agricultural system includes an agricultural implement comprising a plurality of ground engagement tools, wherein each ground engagement tool of the plurality of ground engagement tools is configured to engage soil of a field. Additionally, the agricultural system includes a controller with a memory and a processor, wherein the controller is configured to receive a signal indicative of a speed of a rotational element of the agricultural implement, determine that a difference between the speed of the rotational element and an expected speed of the rotational element of the agricultural implement is greater than a threshold, wherein the expected speed of the rotational element is associated with a no-slip operating condition of the agricultural implement, and reduce an engagement between at least one ground engagement tool of the plurality of ground engagement tools and the soil in response to the difference being greater than the threshold.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural system including an agricultural implement and a work vehicle, in accordance with an aspect of the present disclosure;

FIG. 2 is a schematic diagram of an embodiment of the agricultural system of FIG. 1, including one or more sensors configured to monitor operating conditions of the agricultural system, in accordance with an aspect of the present disclosure;

FIG. 3 is a flow diagram of an embodiment of a method for determining an indication of potential slippage of a work vehicle based on detected operating conditions of an agricultural system, in accordance with an aspect of the present disclosure; and

FIG. 4 is a flow diagram of an embodiment of a method for determining an indication of potential slippage of a work vehicle based on a detected speed of a rotational element of an agricultural implement, in accordance with an aspect of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

Embodiments of the present disclosure relate to an agricultural system used to perform one or more agricultural operations in a field. The agricultural system may include an agricultural implement that may perform the one or more agricultural operations. Furthermore, the agricultural system may include a work vehicle, and the agricultural implement may be coupled to the work vehicle and driven through the field by the work vehicle. The agricultural implement may include at least one ground engaging tool (e.g., tillage point(s), disc harrow(s), rolling basket(s), cultivator shank(s), cultivator sweep(s), opener disc(s), closing disc(s)) configured to engage the soil. For example, the ground engaging tool may include a blade configured to engage the soil of the field to facilitate tilling of the soil, a disc (e.g., an opener disc) configured to engage the soil to form an opening in the soil, a forming point configured to engage the soil to shape an opening formed in the soil (e.g., by an opener disc), or another suitable tool.

However, during operation, moving the ground engaging tool(s) through the field may cause a draft load and/or a draft force on the work vehicle in a direction opposite the direction of travel. The draft load may depend at least in part on the penetration depth of the ground engaging tool(s) relative to the soil surface. For example, increasing the penetration depth of a ground engaging tool may increase the draft load on the work vehicle, and vice versa. Furthermore, the draft load may be affected by operating conditions of the field, such as moisture content of the soil, and operating conditions of the agricultural implement, such as conditions that may increase weight of the agricultural implement. In some instances, the draft load (e.g., draft force) may be high enough to cause the work vehicle wheels and/or tracks to experience slippage relative to the surface of the soil. In particular, the wheels and/or tracks of the work vehicle may move at a different speed (e.g., a higher linear speed) than a ground speed of the work vehicle (e.g., the agricultural system). In some instances, the draft load may cause the work vehicle (e.g., the agricultural system) to stop forward motion all together, or in other words, the work vehicle (e.g., the agricultural system) may become stuck in the soil (e.g., the wheel(s) and/or track(s) may dig into the soil surface). Therefore, the system and method for monitoring operating conditions that may affect the draft load on the work vehicle and then automatically adjust the penetration depth of one or more of the ground engaging tools, as discussed herein, may enable increased control over the draft load on the work vehicle and/or reduced slippage of the work vehicle wheel(s)/track(s) and, thus, may lead to more efficient agricultural operations (e.g., tillage operations, planting operations, seeding operations).

The operating conditions that may affect the draft load on the work vehicle may include conditions of the field (e.g., soil moisture content, soil composition, slope of the field) and/or conditions of the agricultural implement towed by the work vehicle, such as an indication of soil and/or debris buildup on the ground engaging tool(s) and/or wheel(s) of the agricultural implement. In some embodiments, the conditions of the field may be detected using one or more sensors coupled to the agricultural implement and/or to the work vehicle. For example, the soil moisture content and/or soil composition of the field may be detected using a soil sensor (e.g., an optical sensor, a reflectivity sensor, an electrical conductivity sensor) coupled to a ground engaging tool and configured to detect and output an indication of the moisture content and/or the soil composition of the soil of the field. In another example, the slope of the field may be detected using an incline sensor (e.g., inclinometer, accelerometer, a gyroscope) configured to detect the orientation of the agricultural system (e.g., the agricultural implement and/or the work vehicle) and/or movement of the agricultural system (e.g., the agricultural implement and/or the work vehicle) in relation to a vertical axis with respect to gravity. The detected orientation and/or movement of the agricultural system may indicate the slope of a portion of the field in which the agricultural system is located. In some embodiments, the one or more sensors may include an image sensor, such as a camera, configured to capture images of the surface of the field to detect water on the surface of the field and/or to detect the slope of the surface of the field.

Furthermore, in some embodiments, one or more sensors may be used to detect the draft load on the work vehicle. Additionally or alternatively, one or more sensors may be used to detect conditions of the agricultural implement that may affect the draft load. For example, one or more sensors may be used to detect a build-up of soil and/or debris on the ground engaging tool(s) and/or the wheel(s) of the agricultural implement. For example, the build-up of soil and/or debris may be detected using a build-up sensor (e.g., an optical sensor, a reflectivity sensor, an electrical conductivity sensor) coupled to the ground engaging tool(s) and/or the wheel(s) of the agricultural implement. In some embodiments, the build-up sensor may be coupled to the agricultural implement and directed towards the ground engaging tool(s) and/or the wheel(s) to detect the build-up of soil and/or debris on the ground engaging tool(s) and/or the wheel(s). In another example, as discussed herein, an indication that the ground engaging tool(s) and/or the wheel(s) of the agricultural implement may be sliding along the surface of the soil may be determined based on a rotation speed of the ground engaging tool (e.g., rotatable ground engaging tools) and/or the wheel of the agricultural implement compared to an expected rotation speed of the ground engaging tool and/or the wheel of the agricultural implement (e.g., determined based on a speed of the agricultural system). In some instances, the build-up of soil and/or debris on the ground engaging tool(s) and/or the wheel(s) of the agricultural implement may increase the weight of the agricultural implement, and thus increase the draft load of the agricultural implement on the work vehicle. Additionally or alternatively, the build-up of soil and/or debris on the ground engaging tool(s) and/or the wheel(s) of the agricultural implement may cause the ground engaging tool(s) and/or the wheel(s) to slide along the surface of the soil, thus increasing the friction between the agricultural implement and the soil, which may cause an increase in the draft load of the agricultural implement on the work vehicle. In some embodiments, the conditions of the field and/or the soil may impact the conditions of the agricultural implement. Thus, in certain embodiments, the conditions of the field or the conditions of the agricultural implement may be monitored to detect potential changes in the draft load. In some embodiments, some combination of the conditions of the field and the conditions of the agricultural implement may be monitored to detect potential changes in the draft load.

As discussed herein, in some circumstances, the soil may be soft (e.g., caused by a high moisture content) and/or debris may be present on the surface of the soil. The soil and/or debris may collect (e.g., accumulate, stick to, build up) on ground engaging surface(s) of the wheel(s) and/or the disc(s) of the agricultural implement during agricultural operations. The build-up of soil and/or debris may cause the rotational element(s) (e.g., wheel(s), disc(s)) of the agricultural implement to slide (e.g., slip) relative to a surface of the soil. For example, the ground engaging surface of the rotational element may move at a different speed relative to a frame of the agricultural implement than an expected speed (e.g., a linear ground speed of the agricultural implement). For example, the accumulation of soil and/or debris build-up on the ground engaging surface of a wheel/disc may cause the wheel/disc to rotate at a slower rate than an expected rotational rate (e.g., determined based on the ground speed of the agricultural implement). The rotation of the wheel/disc at a slower rate than the expected rotational rate may increase a coefficient of friction between the wheel/disc and the surface of the soil, thereby increasing the draft load of the agricultural implement on the work vehicle.

Thus, the embodiments disclosed herein provide for increased control over the draft load of the agricultural implement by monitoring one or more operating conditions to detect indications of potential slippage of the work vehicle wheel(s)/track(s) (e.g., increases in the draft load of the agricultural implement). Furthermore, the present embodiments discussed herein enable automatic adjustment of the penetration depth of one or more ground engaging tools of the agricultural implement based on the detected indication(s) of potential slippage of the work vehicle wheel(s)/track(s) (e.g., potential increases in the draft load) to reduce the draft load of the agricultural implement and significantly reduce the possibility of the work vehicle wheel(s)/tracks(s) slipping and/or becoming stuck in the soil. For example, embodiments of the present disclosure are directed to monitoring one or more operating condition(s) indicative of potential slip and reducing engagement between a ground engaging tool of the agricultural implement and the soil of the field in response to determining the operating condition(s) indicate potential slippage.

In addition, the agricultural system may include a control system (e.g., including a controller) configured to control operation of the agricultural implement based on the indication of potential slippage. The control system may monitor (e.g., via one or more sensors) the operating condition(s) and compare one or more values of the operating condition(s) with target value(s) (e.g., target range(s) of value(s)) of the respective operating condition(s). The target value and/or target range of values may be associated with a no-slip condition. In some embodiments, the no-slip condition may include slip conditions below a threshold slip amount. Thus, an operating condition value being equal to the corresponding target value and/or within the corresponding target range of values may indicate that current operating conditions of the agricultural implement may not cause the work vehicle to slip (e.g., slip above a threshold slip amount). In this case, no operational adjustments of the agricultural system may be performed based on the operating condition value being equal to a target value and/or within the target range of values. However, in some embodiments, the control system may determine that the value of at least one detected operating condition is not equal to the respective target value or is outside of the respective target range of values. In this case, the operating condition value being different than the target value or outside of the corresponding target range of values may indicate that current operation conditions of the agricultural implement may potentially cause the work vehicle wheel(s)/track(s) to slip. Furthermore, as discussed herein, the operating condition may include a linear speed of a rotational element (e.g., wheel, disc, etc.) of the agricultural implement relative to a ground speed of the agricultural implement. As a result, in response to determining the operating condition value is not equal to the respective target value and/or outside of the respective target range of values, the control system may output a control signal to adjust operation of the agricultural system to reduce the likelihood of slip of the work vehicle wheel(s)/track(s).

The control signal may cause a position of one or more ground engagement tools to adjust with respect to the surface of the soil. For example, the control signal may raise the one or more ground engagement tools with respect to the vertical axis to reduce engagement between the ground engagement tool(s) and the soil. As a result, the reduced engagement with the soil may decrease a draft load of the agricultural implement, and thus, reduce the likelihood of slip of the work vehicle wheel(s)/track(s) due to the draft load. In some embodiments, a position of all or a portion of the one or more ground engagement tools may be adjusted. For example, multiple row units may be coupled to a main frame of the agricultural implement, and the control signal may cause the position of an entirety of the row units to be adjusted, while in some embodiments, the control signal may cause the position of a section of the row units to be adjusted with respect to the surface of the soil. The section of the row units may correspond to a location on the agricultural implement of the detected indication of slip.

Furthermore, in some embodiments, the control signal may cause a down pressure of one or more of the ground engaging tools to decrease, thereby decreasing the draft load of the agricultural implement. For example, a down pressure is applied to one or more ground engaging tools to urge the ground engaging tool(s) toward the surface of the soil. In certain embodiments, an agricultural implement includes one or more actuators (e.g., hydraulic actuator(s), electric actuator(s), pneumatic actuator(s), etc.) and/or one or more sensors that are each communicatively coupled to the control system. At least one actuator may be coupled to each ground engaging tool, and the control system may control down pressure, via the actuator(s), of each ground engaging tool (e.g., based on feedback received from the one or more sensors). For example, the one or more sensors may include pressure sensor(s) that detect pressure(s) of hydraulic fluid inside respective hydraulic actuator(s). Each pressure sensor may output a respective sensor signal indicative of the detected hydraulic fluid pressure to the controller, and the controller may determine the down pressure of the ground engaging tool based on the detected hydraulic fluid pressure. In response to the determined down pressure being greater than or less than a target pressure/target pressure range, the control system may control each respective actuator to increase or decrease the down pressure to substantially equal the target pressure/be within the target pressure range. In this way, the control system may provide substantially consistent down pressure of the ground engaging tool(s) while in operation.

Moreover, when the controller receives an indication of potential slippage of the work vehicle wheel(s)/track(s), the controller may output the control signal to control the one or more actuators to decrease the down pressure of the ground engaging tool(s). In certain embodiments, the control signal may override the normal working operations, as discussed herein, that provide for a consistent down pressure substantially equal to the target down pressure. In some embodiments, the target down pressure may be determined and/or adjusted based on the indication of potential slippage. For example, the controller may receive an indication of potential slippage of the work vehicle wheel(s)/track(s) and decrease the target down pressure of one or more of the ground engaging tool(s). The decrease in down pressure of the one or more ground engaging tools may enable the ground engaging tool(s) to float on the surface of the soil. As a result, the draft load of the agricultural implement is reduced and, thus, the likelihood of work vehicle wheel/track slippage is reduced.

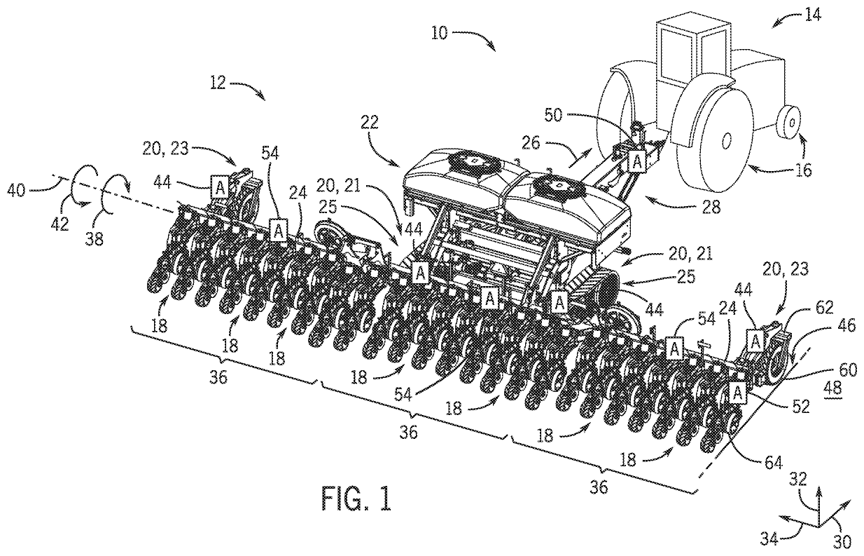

FIG. 1 is a perspective view of an embodiment of an agricultural system 10 including an agricultural implement 12 (e.g., planting implement) and a work vehicle 14. In the illustrated embodiment, the work vehicle 14 is a tractor. However, in some embodiments, the work vehicle may be an on-road truck, a harvester, and so forth, that may be driven over a field. In any case, the work vehicle 14 may include one or more wheels and/or tracks 16 that operate to move the work vehicle 14 across the field. In the illustrated embodiment, the agricultural implement 12 includes multiple row units 18 (e.g., each having ground engaging tool(s)) distributed across a width of the agricultural implement 12. The agricultural implement 12 also includes one or more wheel/track assemblies 20, a main frame 22, and one or more toolbar assemblies 24. In the illustrated embodiment, the wheel/track assemblies 20 include main track assemblies 21 and guide wheel assemblies 23. Each guide wheel assembly 23 includes one or more wheels 60 and a wheel frame 62. Furthermore, the main track assemblies 21 include one or more tracks 25. The wheel/track assemblies 20 are configured to support at least a portion of the weight of the main frame 22, the one or more toolbar assemblies 24, the row units 18, agricultural product storage tank(s), agricultural product (e.g., seed, fertilizer) within the agricultural product storage tank(s), and other components of the agricultural implement 12. The agricultural implement 12 is configured to be towed through a field behind the work vehicle 14, such as the tractor, in a forward direction of travel 26. As illustrated, the agricultural implement 12 includes the main frame 22, which includes a hitch assembly 28 configured to couple the agricultural implement 12 to an appropriate tractor hitch (e.g., via a ball, clevis, or other coupling).

The main frame 22 is coupled to the one or more toolbar assemblies 24, which support the multiple row units 18. Furthermore, each row unit 18 may include one or more opener discs and/or one or more gauge wheels 64. The gauge wheels 64 may be configured to roll along the surface 46 of the soil 48, and the opener discs may be configured to form trenches within soil 48 of the field. A depth of each trench may be controlled based on a spatial relation between a position of opener disc(s) and a position of the gauge wheel(s) 64. Moreover, each row unit 18 may also include an agricultural product conveying system (e.g., seed tube or powered agricultural product conveyer) configured to deposit the agricultural product into the trench. In addition, each row unit 18 may include closing disc(s) and/or a packer wheel positioned behind the agricultural product conveying system. The closing disc(s) are configured to move displaced soil back into the trench, and the packer wheel is configured to pack soil on top of the deposited agricultural product. Furthermore, each row unit 18 may include an agricultural product meter configured to control a flow of the agricultural product into the agricultural product conveying system, thereby controlling agricultural product spacing within the soil. To facilitate discussion below, the agricultural implement 12 and its respective components may be described with reference to a longitudinal axis 30, a vertical axis 32, which is oriented relative to a direction of gravity, and a lateral axis 34. The longitudinal axis 30 may be generally aligned with the forward direction of travel 26.

In the illustrated embodiment, the row units 18 form segments of row units 36, and each of the segments of row units 36 is attached to the main frame 22 via a corresponding toolbar assembly 24. Thus, a position of each segment of row units 36 may be controllably adjusted independently of each other. For example, in some embodiments, one or more tool bar actuators 54 (e.g., hydraulic cylinder(s), double-acting hydraulic cylinder(s), electric actuators, etc.) may be controllably extended or retracted to change a position (e.g., a height) of each segment of row units 36 in relation to the surface 46 of the soil 48. For example, in some embodiments, each segment of row units 36 may be rotated upwardly (e.g., via rotation of the respective toolbar assembly 24 about the lateral axis 34 from the illustrated working position (e.g., in which the row units 18 are engaged with the soil 48) to a non-working position (e.g., non-ground engaging position, headland position, transport position), which may reduce the draft load of the agricultural implement on the work vehicle. For example, at least a portion of the toolbar assemblies 24 may be rotated in a first rotational direction 38 about an axis of rotation 40 that is substantially parallel to the lateral axis 34, thereby rotating the respective segment(s) of row units 36 coupled to the portion(s) of the toolbar assemblies 24 from the working position to the non-working position. In addition, at least a portion of the toolbar assemblies 24 may be rotated in a second rotational direction 42 about the axis of rotation 40 (e.g., opposite the first rotational direction 38), thereby rotating the respective segment(s) of row units 36 coupled to the portion(s) of the adjustable toolbar assemblies 24 from the non-working position to the working position. As a result, the row units 18 are positioned to engage the soil, thereby enabling the row units 18 to deposit the agricultural product within the soil as the agricultural implement 12 traverses the field.

Additionally or alternatively, the position of each of the segments of row units 36 may be adjusted in coordination with adjusting the height of the main frame 22. For example, in some embodiments, the agricultural system 10 may include one or more wheel assembly actuator(s) 44 (e.g., hydraulic cylinder(s), double-acting hydraulic cylinder(s), electric actuators, etc.), in which each wheel assembly actuator 44 is coupled to the main frame 22 and/or the tool bar assembly/assemblies 24 and to the wheel frame of the wheel/track assembly 20. The one or more wheel assembly actuators 44 may be configured to control one or more positions of the wheel/track assembly/assemblies 20 relative to the main frame 22 and/or the tool bar assembly/assemblies 24 with respect to the vertical axis 32, and thus control a height of the main frame 22 and/or the tool bar assemblies 24 above the surface 46 of the soil 48. In this way, the one or more wheel assembly actuators 44 may additionally control the penetration depth of the one or more ground engaging tools, such as the illustrated row units 18, in relation to the surface 46 of the soil 48. In particular, the one or more wheel assembly actuators 44 may enable the entirety of the row units 18 to be raised to a non-working position (e.g., unengaged with the soil 48), such as to facilitate transport and/or headland turns of the agricultural implement 12. While the agricultural system 10 of the illustrated embodiment includes four wheel assembly actuators 44, in other embodiments, the agricultural system 12 may include more or fewer wheel assembly actuator(s) 44 extending between the main frame 22 and/or the tool bar assembly/assemblies 24 and the wheel/track assembly/assemblies 20 of the agricultural implement 12.

In certain embodiments, each wheel assembly actuator 44 may be configured to move the respective wheel/track assembly 20 from a retracted position (e.g., in which the wheel/track assembly 20 is raised, and the main frame 22 and/or tool bar assembly/assemblies 24 are lowered) to an extended position (e.g., in which the wheel/track assembly 20 is lowered, and the main frame 22 and/or tool bar assembly/assemblies 24 are raised). When the wheel/track assembly/assemblies 20 are in the extended position, the ground engaging tools (e.g., of the row units 18) of the agricultural implement 12 are raised and may be disengaged from the soil 48 (e.g., to reduce the draft load, to facilitate transport, to facilitate inspection of the agricultural implement 12, to facilitate a headland turn, etc.). Each wheel assembly actuator 44 may move the respective wheel/track assembly 20 from the extended position to the retracted position, thereby causing the ground engaging tools (e.g., of the row units 18) to lower and engage the soil 48. In some embodiments, the position of the main frame 22 and/or the tool bar assemblies 24 may be controlled based on positions of the wheel assembly actuators 44, thereby enabling the ground engaging tools of a portion of the row units 18 to be raised and/or lowered (e.g., to tilt or slope the main frame 22 and/or one or more tool bar assemblies 24 about the longitudinal axis 30, etc.). In addition, in some embodiments, the agricultural system 10 may include one or more other actuator(s) (e.g., hitch position actuator 50, etc.) that may be controlled alone or in combination with the wheel assembly actuator(s) 44 to establish a target main frame height/target position of the main frame 22 and/or target toolbar assembly height(s)/target position(s) of the toolbar assembly/assemblies 24 during operation.

While the illustrated agricultural implement 12 includes seven, eight, or nine row units 18 per respective segment of row units 36, in other embodiments, the agricultural implement 12 may include more or fewer row units per segment of row units 18 (e.g., 3, 4, 5, 6, 10, 12, or more). Further, in some embodiments, the row units 18 may be coupled to a single tool bar assembly 24 that is coupled to the main frame 22. In certain embodiments, the row units 18 may be coupled (e.g., rotatably coupled) directly to the main frame 22.

Furthermore, in some embodiments, the agricultural system 10 may include one or more tool actuators 52 (e.g., hydraulic cylinder(s), double-acting hydraulic cylinder(s), electric actuators, etc.), in which each tool actuator 52 extends between a tool bar assembly 24 and a respective row unit 18. Furthermore, when one or more of the row units 18 are in the working position (e.g., engaged with the surface 46 of the soil 48), the tool actuators 52 may be controlled to urge the row units 18 toward the surface 46 of the soil 48, such that the row units 18 engage with the soil 48. As a result, the tool actuators 52 may be used to adjustably drive each row unit 18 to engage with the soil 48 with a down pressure to achieve the target tool penetration of the opener disc(s). In some embodiments, the down pressure (e.g., hydraulic pressure, mechanical pressure) of the tool actuators 52 may be controllably adjusted to enable the respective the row units 18 to disengage from the soil 48 and/or float along the surface 46 of the soil 48 (e.g., decrease the opener penetration depth), thereby reducing the draft load of the agricultural implement 12. In addition, in some embodiments, the tool actuators 52 may be controlled alone or in combination with the wheel assembly actuator(s) 44, the tool bar actuator(s) 54, the hitch assembly actuator(s) 50, or any combination thereof to adjust the position of the row units 18 in relation to the soil 48 and/or the downforce applied by the row units 18 to the soil surface 46, thereby controllably adjusting the draft load (e.g., increase or decrease) of the agricultural implement 12 during operation.

In additional or alternative embodiments, the agricultural implement may have any suitable alternate configurations, such as having no wheel assemblies, no tool bar assembly/assemblies with ground engaging tools/row units coupled directly to the main frame, any other suitable configuration, or any combination thereof. The agricultural implement may also be a different type or configuration of a planting implement, or the agricultural implement may be a different type of agricultural implement, such as a tillage implement, a seeding implement, a harvesting implement, a sprayer, a mower, and the like, and may be configured to perform a different agricultural operation on the field. Furthermore, the agricultural implement may include additional or alternative ground engaging tool(s), such as tillage point(s), disc harrow(s), rolling basket(s), cultivator shank(s), cultivator sweep(s), opener disc(s), closing disc(s), or any combination thereof. Furthermore, in additional or alternative embodiments, the work vehicle and/or the agricultural implement may have a set of wheels, a set of tracks, or a combination of both.

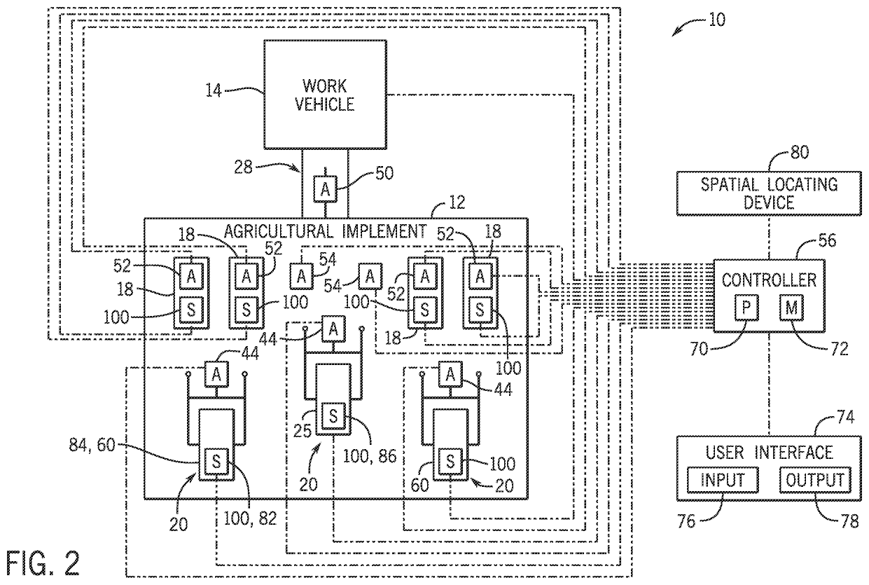

FIG. 2 is a block diagram of an embodiment of the agricultural system 10 having the work vehicle 14, the agricultural implement 12, and one or more sensors 100 configured to monitor operating conditions. As discussed herein, the operating conditions may affect the draft load of the agricultural implement 12. The operating conditions may include detected conditions of the field (e.g., soil moisture content, soil composition, slope of the field) and/or detected conditions of portions of the agricultural implement 12 towed by the work vehicle 14, such as an indication of soil and/or debris buildup on the ground engaging tool(s) and/or the wheel(s) 60/track(s) 25 of the agricultural implement 12. In the illustrated embodiment, the sensors 100 are coupled to the wheel/track assemblies 20 and to the row units 18. Additionally or alternatively, in some embodiments, one or more sensors 100 may be coupled to other portion(s) of the agricultural system 10, such as the main frame 22, the tool bar assemblies 24, an independent non-tool ground engaging element (e.g., coupled to the agricultural implement 12 and/or the work vehicle 14), or any combination thereof.

As discussed herein, the one or more sensors 100 may be configured to detect the operating conditions. Furthermore, the agricultural system 10 includes a controller 56 communicatively coupled to the one or more sensors 100. As such, each sensor 100 may detect at least one operating condition and output a signal indicative of the operating condition(s) to the controller 56. In some embodiments, the conditions of the field may be detected using the sensors 100. For example, the soil moisture content and/or the soil composition of the field may be detected using a soil sensor (e.g., an optical sensor, a reflectivity sensor, an electrical conductivity sensor), which may be coupled to a row unit 18 or to a wheel/track assembly 20. The soil sensor is configured to detect and output a signal indicative of the moisture content and/or the soil composition of the soil of the field to the controller 56. In another example, the slope of the field may be detected using an incline sensor (e.g., inclinometer, accelerometer, a gyroscope) coupled to the agricultural implement 12 or to the work vehicle 14 and configured to detect the orientation of the agricultural system 10 (e.g., the agricultural implement and/or the work vehicle) and/or movement of the agricultural system 10 (e.g., the agricultural implement 12 and/or the work vehicle 14) in relation to the vertical axis 32 with respect to gravity. The detected orientation and/or movement of the agricultural system 10 may indicate the slope of a portion of the field in which the agricultural system 10 is located. In some embodiments, the one or more sensors 100 may include an image sensor, such as a camera, which may be coupled to the agricultural implement 12 and/or the work vehicle 14. The camera is configured to capture images of the surface of the soil to detect water on the surface of the soil and/or to detect the slope of the surface of the soil.

Furthermore, in some embodiments, one or more sensors 100 may be used to detect the draft load of the agricultural implement 12 and/or portions of the agricultural implement 12 (e.g., the ground engaging tool(s)) on the work vehicle 14. Additionally or alternatively, in some embodiments, the conditions of portions of the agricultural implement 12 may be detected by one or more sensors 100. For example, one or more sensors 100 may be used to detect a build-up of soil and/or debris on the row units 18 (e.g., the ground engaging tools of the row units) and/or the wheels 60/tracks 25 of the wheel/track assemblies 20 of the agricultural implement 12. For example, the build-up of soil and/or debris may be detected using a build-up sensor (e.g., an optical sensor, a reflectivity sensor, an electrical conductivity sensor), which may be coupled to a row unit 18 and/or a wheel/track assembly 20 of the agricultural implement 12. Furthermore, in some embodiments, as discussed herein, an indication that a row unit 18 (e.g., a ground engaging tool of the row unit) or a wheel 60/track 25 of the agricultural implement 12 is sliding along the surface of the soil may be determined based on a detected linear speed or a detected rotational rate (e.g., rotational speed) of the ground engaging tool or the wheel 60/track 25 of the agricultural implement 12, as compared to an expected linear speed or an expected rotational rate of the ground engaging tool or the wheel 60/track 25.

As discussed herein, in some circumstances, the soil may be soft (e.g., caused by a high moisture content) and/or debris may be present on the surface of the soil. The soil and/or debris may collect (e.g., accumulate, stick to, build up) on ground engaging surface(s) of the wheel(s) 60/track(s) 25 and/or rotatable ground engaging tool(s) (e.g., gauge wheels, discs) of the agricultural implement 12 during agricultural operations. The build-up of soil and/or debris may cause the wheel(s) 60/track(s) 25 and/or the rotatable ground engaging tool(s) of the agricultural implement 12 to slide (e.g., slip) along the surface of the soil. For example, the ground engaging surface of the wheel 60/track 25 or the rotatable ground engaging tool may move at a different speed relative to the frame/toolbar assembly of the agricultural implement 12 than an expected speed (e.g., detected ground speed of the agricultural system 10). For example, the speed of the wheel(s)/track(s) 60 and/or the ground engaging tool(s) may be detected using a speed sensor (e.g., radar sensor, tachometer). Furthermore, the accumulation of soil and/or debris build-up on the ground engaging surface of a wheel 60/track 25 or a ground engaging tool may cause the wheel/track/ground engaging tool to rotate at a slower detected rate than an expected rotational rate (e.g., determined based on the detected ground speed of the agricultural implement 12). The rotation of the wheel 60/track 25/ground engaging tool at a slower rate than the expected rotational rate may increase a coefficient of friction between the wheel 60/track 25/ground engaging tool and the surface of the soil, thereby increasing the draft load of the agricultural implement 12 on the work vehicle 14 and increasing the potential for slippage of the work vehicle wheel(s)/track(s).

Furthermore, additionally or alternatively, the build-up of soil and/or debris on the ground engaging tool(s) and/or the wheel(s) 60/tracks(s) 25 of the agricultural implement 12 may increase a weight of the agricultural implement 12, and thus increase the draft load of the agricultural implement 12 on the work vehicle 14. Moreover, the build-up of soil and/or debris on the ground engaging tool(s) and/or the wheel(s) 60/track(s) 25 of the agricultural implement 12 may cause the ground engaging tool(s) and/or the wheel(s) 60/track(s) 25 to slide along the surface of the soil, thereby increasing the friction between the agricultural implement 12 and the soil, which may cause an increase in the draft load of the agricultural implement 12 on the work vehicle 14. In some embodiments, the conditions of the field and/or the soil may impact the conditions of the agricultural implement 12. Thus, in certain embodiments, the conditions of the field or the conditions of the agricultural implement 12 may be monitored to detect an indication of potential changes in the draft load. In some embodiments, some combination of the conditions of the field and the conditions of the agricultural implement may be monitored to detect an indication of potential changes in the draft load.

The controller 56, as discussed herein, may provide for increased control over the draft load of the agricultural implement by monitoring one or more operating conditions to detect indications of potential changes to the draft load of the agricultural implement 12 (e.g., increases in the draft load of the agricultural implement 12). Furthermore, the controller 56 provides automatic adjustment of the penetration depth of one or more ground engaging tool(s) of the agricultural implement 12 based on the detected indications of potential changes in the draft load (e.g., increases in the draft load) to control the draft load of the agricultural implement 12 and significantly reduce the possibility of the work vehicle 14 slipping and/or becoming stuck in the soil. For example, the controller 56 may monitor one or more operating conditions indicative of potential slip (e.g., potential increases in the draft load) and reduce engagement between ground engaging tool(s) of the agricultural implement 12 and the soil of the field in response to determining the operating condition indicates potential slippage.

In addition, as discussed herein, the controller 56 is configured to control operation of the agricultural implement 12 based on the indication of potential slippage (e.g., potential increases in the draft load). In certain embodiments, the controller 56 is an electronic controller having electrical circuitry configured to process data from the one or more sensors 100 and to output instructions (e.g., via control signals) to the wheel assembly actuators 44, to the hitch actuator 50, the tool bar actuators 54, the tool actuators 52, to a controller of the work vehicle 14, or a combination thereof. The controller 56 may communicate with the wheel assembly actuators 44, the hitch actuator 50, the tool bar actuators 54, the tool actuators 52, the one or more sensors 100, the work vehicle controller, or any combination thereof using any suitable communication protocol, such as a standard communication protocol (e.g., controller area network (CAN) bus, ISOBUS, etc.) or a proprietary protocol. In the illustrated embodiment, the controller 56 includes a processor 70, such as a microprocessor, and a memory device 72. The controller 56 may also include one or more storage devices and/or other suitable components. The processor 70 may be used to execute software, such as software for controlling the wheel assembly actuators 44, the hitch actuator 50, the tool bar actuators 54, the tool actuators 52, or a combination thereof, software for controlling the work vehicle 14, and so forth. Moreover, the processor 70 may include multiple microprocessors, one or more “general-purpose” microprocessors, one or more special-purpose microprocessors, one or more application specific integrated circuits (ASICS), and/or one or more field-programmable gate arrays (FPGA), or some combination thereof. For example, the processor 70 may include one or more reduced instruction set (RISC) processors.

The memory device 72 may include a volatile memory, such as random access memory (RAM), and/or a nonvolatile memory, such as read-only memory (ROM). The memory device 72 may store a variety of information and may be used for various purposes. For example, the memory device 72 may store processor-executable instructions (e.g., firmware or software) for the processor 70 to execute, such as instructions for controlling the wheel assembly actuators 44, the hitch actuator 50, the tool bar actuators 54, the tool actuators 52, or a combination thereof, instructions for controlling the work vehicle 14, and so forth. The memory device 72 may also store location information related to the one or more sensors 100 and/or the location of the agricultural implement 12. The storage device(s) (e.g., nonvolatile storage) may include ROM, flash memory, a hard drive, or any other suitable optical, magnetic, or solid-state storage medium, or a combination thereof. The storage device(s) may store data (e.g., one or more threshold values, etc.), instructions (e.g., software or firmware for controlling the actuator(s), etc.), and any other suitable data.

In the illustrated embodiment, the agricultural system 10 includes a user interface 74 communicatively coupled to the controller 56. The user interface 74 is configured to receive input from an operator (e.g., a human operator) and to provide information to the operator. The user interface 74 may include any suitable input device(s) 76 for receiving input, such as a keyboard, a mouse, touch screen(s), button(s), switch(es), knob(s), other suitable input device(s), or any combination thereof. In addition, the user interface 74 may include any suitable output device(s) 78 for presenting information to the operator, such as speaker(s), indicator light(s), display(s), other suitable output device(s), or any combination thereof. For example, the user interface 74 may enable the operator to provide inputs to set a target tool penetration depth, a target down pressure, a target draft load, or a combination thereof, to set the target condition value(s) and/or target condition value range(s) for the one or more operational conditions, to input the locations of the soil sensor(s) 100, to override the automatically controlled operational positions of the one or more ground engaging tools, to control any of the wheel assembly actuators 44, the tool bar actuators 54, the hitch assembly actuators 50, and the tool actuators 52, or any combination thereof. Additionally or alternatively, the user interface 74 may present (e.g., via a display, indication, notification) the tool penetration depth(s), the down pressure(s), the draft load, the operational condition value(s), an indication of potential slippage of the work vehicle wheel(s)/track(s), an indication of whether the current tool penetration depth meets a target tool penetration depth and/or whether the current down pressure meets the target down pressure, the set target condition value(s) and/or the target condition value range(s), the locations of the one or more sensors 100, current control instruction(s) being output to the wheel assembly actuators 44, the tool bar actuators 54, the hitch assembly actuator 50, and/or the tool actuators 52, or any combination thereof.

In certain embodiments, the controller 56 may monitor (e.g., via the one or more sensors 100) the operating condition(s) of the agricultural system 10 and compare the value of each monitored operating condition with a respective target value (e.g., respective target range of values) of the operating condition. Each target value and/or each target range of values may be associated with a no-slip condition (e.g., a slip condition below a threshold slip), which may indicate a draft load is at or below a threshold draft load. Thus, an operating condition value being substantially equal to the corresponding target value and/or within the corresponding target range of values may indicate that the current operating condition may not cause the work vehicle wheel(s)/track(s) to slip (e.g., slip above a threshold slip amount). In this case, no operational adjustments of the agricultural system 10 (e.g., the agricultural implement 12 and/or the work vehicle 14) may be performed based on the operating condition value being substantially equal to the target value and/or within the target range of values. However, the controller 56 may determine that the value of the detected operating condition is not substantially equal to the respective target value and/or outside of the respective target range of values. In this case, the operating condition value being different than the target value and/or outside of the corresponding target range of values may indicate that the current operating condition may potentially cause the work vehicle wheel(s)/track(s) to slip (e.g., the draft load is above the threshold draft load). In some embodiments, values of various operating conditions may be added to generate a total operating condition value that is then compared to a target total operating condition value and/or a range of target total operating condition values.

In response to determining the operating condition value is not substantially equal to the respective target value and/or outside of the respective target range of values, the controller 56 may output a control signal to adjust operation of the agricultural system 10 to reduce the likelihood of slippage of the work vehicle 14 (e.g., to reduce the draft load). The control signal may cause the position of the one or more ground engagement tools (e.g., of the row units 18) to adjust with respect to the surface of the soil. For example, the control signal may cause the one or more ground engagement tools to be raised, with respect to the vertical axis, to reduce engagement between the ground engagement tool(s) and the soil. The reduced engagement with the soil may decrease a draft load of the agricultural implement 12, and thus, reduce the likelihood of slippage of the work vehicle wheel(s)/track(s) due to the draft load. The wheel assembly actuators 44 are communicatively coupled to the controller 56 and configured to receive a control signal from the controller 56. Moreover, when the controller 56 receives an indication of potential slippage of the work vehicle 14 (e.g., via determining at least one operating condition value is not substantially equal to a respective target value and/or outside a respective target range of values), the controller 56 may control the one or more wheel assembly actuators 44 to extend, thereby increasing the height of the main frame and/or the tool bar assemblies above the surface of the soil. By increasing the height of the main frame and/or the tool bar assemblies, position(s) of the one or more ground engaging tools (e.g., of the row units 18) coupled to the main frame and/or the tool bar assemblies in relation to the soil may also be changed. For example, in some embodiments, as the height of the main frame and/or the tool bar assemblies increases, with respect to the surface of the soil, the one or more ground engaging tools may be raised out of the soil and thus be disengaged from the surface of the soil. In some embodiments, the one or more ground engaging tools may be raised to reduce engagement with the surface of the soil. As discussed herein, a decrease in engagement with the soil (e.g., decrease in penetration depth) of the one or more ground engaging tools may also decrease the draft load of the agricultural implement 12 on the work vehicle 14.

In some embodiments, a portion of the ground engaging tools may be adjusted. For example, the controller 56 may control (e.g., via the control signal) a position of one of the segments of row units with respect to the surface of the soil. In some embodiments, the one or more tool bar actuators 54 are communicatively coupled to the controller 56, and the controller 56 may control the tool bar actuators 54 to extend or retract. For example, the controller 56 may control a tool bar actuator 54 to rotate a respective segment of row units in the first rotational direction, thereby decreasing the engagement of the segment of row units with the soil. The controller may determine which segment of row units (e.g., the respective tool bar actuator) to control based on determining location(s) of the indication(s) of potential slippage of the work vehicle 14. For example, each sensor 100 may be associated with a location on the agricultural implement 12, which may correspond to a location on the agricultural implement 12 where the sensor 100 is coupled. In some embodiments, the controller 52 may receive an indication of the location of the sensor 100 on the agricultural implement 12. In some embodiments, the signal output by each sensor 100 may include sensor identification information associated with the sensor 100, which the controller 52 may use to determine the location of the sensor 100 on the agricultural implement 12. For example, the sensor identification information and the corresponding location of each sensor 100 on the agricultural implement 12 may be stored (e.g., within the memory device 72), such as in a lookup table, and the controller 52 may determine the location of the sensor 100 based on the received sensor identification information. In some embodiments, the locations of the sensors 100 may be received by the controller 56 via input from the user interface 74 (e.g., from the operator). Additionally or alternatively, the location of the sensors 100 may be established in some other way, such as by being pre-programmed into the controller 56 by a manufacturer.

Additionally or alternatively, in some embodiments, the control signal may cause a down pressure of one or more of the ground engaging tools to decrease, thereby decreasing the draft load of the agricultural implement. The tool actuators 52 are communicatively coupled to the controller 56, and each tool actuator 52 is configured to receive a control signal from the controller 56. Moreover, when the controller 56 receives an indication of potential slippage of the work vehicle 14 (e.g., via determining at least one operating condition value is not substantially equal to a respective target condition value and/or outside a respective target range of condition values), the controller 56 may control one or more tool actuators 52 to retract and/or to reduce the down pressure on the respective ground engaging tool(s), thereby decreasing the force applied by the respective ground engaging tool(s) to the surface of the soil (e.g., enabling the ground engaging tool(s) to float along the surface of the soil). As discussed herein, a decrease in engagement with the soil (e.g., decrease in penetration depth, decrease in downforce) of one or more ground engaging tools may also decrease the draft load of the agricultural implement 12 and, thus, the likelihood of the work vehicle wheel(s)/track(s) slipping.

Furthermore, as discussed herein, the operating condition value may include the detected speed (e.g., linear speed, rotational rate/speed) of a rotational element (e.g., wheel 60, gauge wheel, track 25) of the agricultural implement 12, and the target condition value and/or the range of target condition values may be associated with an expected speed (e.g., expected linear speed, expected rotational rate/speed) of the rotational element, which may be determined based on the detected ground speed of the agricultural system 10 (e.g., the agricultural implement 12, the work vehicle 14). In particular, in some embodiments, the rotational element may be a non-powered rotational element (e.g., non-powered wheel, non-powered disc) of the agricultural implement. In other words, the rotational element may be driven to rotate by contact with the surface of the soil in combination with a force (e.g., movement) of the agricultural implement and/or work vehicle driving the agricultural implement across the field, and not by a respective motor or engine.

In some embodiments, the detected ground speed of the agricultural system 10 may be received from a work vehicle controller, and may be associated with a transmission speed of the work vehicle 14. Additionally or alternatively, the detected ground speed of the agricultural system 10 may be determined via a radar sensor and/or a tachometer coupled to the work vehicle 14. In the illustrated embodiment, the agricultural system 10 includes a spatial locating device 80 communicatively coupled to the controller 56. The spatial locating device may be coupled to the agricultural implement 12 or, in some embodiments, to the work vehicle 14. Further, the spatial locating device 80 is configured to output a signal (e.g., positional data) indicative of a position (e.g. location) of the agricultural implement 12 and/or the work vehicle 14. The spatial locating device 80 may include any suitable system configured to measure and/or facilitate determination of the position of the agricultural implement 12 and/or the work vehicle 14, such as a global positioning system (GPS) receiver, for example. The spatial locating device 80 may output the signal (e.g., positional data) indicative of the position (e.g., location) of the agricultural implement 14 and/or the work vehicle 12 to the controller 56. Furthermore, the controller 56 may receive the positional data and determine the ground speed of the agricultural system 10 based on the positional data. In some embodiments, the spatial locating device 80 may output the detected ground speed of the agricultural system 10 to the controller 56.

The controller 56 may determine the expected speed (e.g., expected linear speed, expected rotational rate/speed) of each rotational element (e.g., wheel 60, gauge wheel, track 25) based on the ground speed of the agricultural system 10. For example, the controller 56 may determine the ground speed of the agricultural system 10 and determine the expected linear speed of each rotational element based on the ground speed. If the agricultural system is moving along a straight path, the expected linear speed of each rotational element may be determined based on the ground speed of the agricultural system and the diameter of the rotational element (e.g., radius of the rotational element). However, if the agricultural system is moving along a curved path, the expected linear speed may be determined based on the ground speed of the agricultural system, the diameter of the rotational element, a radius of curvature of the curved path, and a location of the rotational element on the agricultural implement. The diameter of each rotational element may be stored (e.g., within the memory device 72), such as in a lookup table, and associated with a respective rotational element on the agricultural implement 12. In some embodiments, the expected linear speed of at least one rotational element may be received by the controller 56 via input from the user interface 74 (e.g., from the operator). Additionally or alternatively, the expected linear speed associated with at least one rotational element may be established in some other way, such as by being pre-programmed into the controller 56 by a manufacturer.

Moreover, the controller 56 may determine the expected rotational rate (e.g., expected rotational speed) of each rotational element (e.g., wheel 60, gauge wheel, track 25) based on the ground speed of the agricultural system 10. For example, the controller 56 may determine the ground speed of the agricultural system 10 and determine the expected rotational rate of each rotational element based on the ground speed and the diameter of the rotational element (e.g., circumference of the rotational element). If the agricultural system is moving along a straight path, the expected rotational rate of each rotational element may correspond to the ground speed of the agricultural system. However, if the agricultural system is moving along a curved path, the expected rotational rate may be determined based on the ground speed of the agricultural system, a radius of curvature of the curved path, and a location of the rotational element on the agricultural implement. As discussed herein, the diameter of each rotational element may be stored (e.g., within the memory device 72), such as in a lookup table, and associated with a respective rotational element on the agricultural implement 12. In some embodiments, the expected rotational rate of at least one rotational element may be received by the controller 56 via input from the user interface 74 (e.g., from the operator). Additionally or alternatively, the expected rotational rate associated with at least one rotational element may be established in some other way, such as by being pre-programmed into the controller 56 by a manufacturer.

Furthermore, as discussed herein, each sensor 100 may be associated with and configured to monitor at least one rotational element (e.g., wheel 60, gauge wheel 64, track 25). For example, in the illustrated embodiment, a first sensor 82 of the sensors 100 is associated with and configured to monitor a wheel 84 of the wheels 60, and a second sensor 86 of the sensors 100 is associated with and configured to monitor a track 25 of the agricultural implement 12. The associations between the one or more sensors 100 and the respective rotational element(s) may be stored (e.g., within the memory device 72). Furthermore, each sensor 100 may be configured to detect the linear speed and/or the rotational rate of respective rotational element(s). For example, the controller 56 may receive a detected linear speed associated with the wheel 84 from the first sensor 82. Then, based on the association between the first sensor and the wheel 84, and using techniques discussed herein, the controller 56 may determine the expected linear speed of the wheel based on the ground speed of the agricultural system 10 and then compare the first detected linear speed with the expected linear speed of the wheel 84. The controller 56 may then determine if the detected linear speed of the wheel 84 is substantially equal to (e.g., within a threshold difference of) the expected linear speed of the wheel 84 and/or within a range of expected linear speeds of the wheel 84 to identify a potential change in the draft load, thereby identifying potential slippage of the work vehicle 14. In another example, the controller 56 may receive a detected rotational rate associated with the track 25 from the second sensor 86. Then, based on the association between the second sensor 86 and the track 25, and using techniques discussed herein, the controller 56 may determine the expected rotational rate of the track 25 based on the ground speed of the agricultural system 10 and then compare the detected rotational rate with the expected rotational rate of the track 25. The controller 56 may then determine if the detected rotational rate of the track 25 is substantially equal to (e.g., within a threshold difference of) the expected rotational rate of the track 25 and/or within a range of expected rotational rates of the track 25 to identify a potential change in the draft load, thereby identifying potential slippage of the work vehicle 14.

In some embodiments, the controller 56 may be configured to compare each detected operating condition value (e.g., rotational rate, linear speed) associated with a respective rotational element to an average detected operating condition value to identify potential slippage of the work vehicle 14. For example, the controller 56 may be configured to determine an average detected operating condition value associated with all of the monitored rotational elements of the agricultural implement 12, and compare the detected operating condition value of each rotational element to the average detected operating condition value. If a detected operating condition value is more than a threshold amount greater than the average detected operating condition value, the controller 56 may identify potential slippage of the work vehicle 14. The controller 56 may output a signal (e.g., control signal) to decrease the penetration depth of the ground engaging tools, a portion of the ground engaging tools determined based on a location of the ground engaging tools, or a single ground engaging tool based on a location of the ground engaging tool in response to the detected operating condition value differing from the average detected operating condition value (e.g., indication of potential slippage of the work vehicle 14). Similar techniques, as discussed above, may be used to compare other operating condition values with average operating condition values to identify potential slippage of the work vehicle 14, such as soil moisture, slope of the field, soil composition, or any combination thereof.

While the system disclosed above with reference to FIG. 2 includes a single controller 56 configured to receive sensor signals indicative of operating conditions, to identify an indication of slippage of the work vehicle 14 (e.g., indication of an increase in the draft load), and to control the amount of engagement (e.g., penetration depth) of the ground engaging tools of the agricultural implement 12 based on the indication, in other embodiments, the implement monitoring and ground engaging tool control process, as described herein, may be performed by a controller of the work vehicle 14 or a combination of the controller 56 and the controller of the work vehicle 14. Furthermore, in certain embodiments, the agricultural implement 12 may be self-propelled. In such embodiments, elements and systems that may be communicatively coupled to the controller of the work vehicle (e.g., a steering control system, a speed control system) may be communicatively coupled to the controller 56. In such embodiments, the controller 56 may control a speed of the agricultural implement 12 via the speed control system. In addition, in certain embodiments, the user interface 74 may be positioned remote from the work vehicle 14 and/or the agricultural implement 12 (e.g., in embodiments in which the agricultural system 10 is controlled by a remote operator). Furthermore, as discussed herein, in some embodiments, the agricultural system 10 may include one or more sensors 100 configured to monitor one or more non-tool ground engaging elements of the agricultural implement 12. For example, the sensor(s) 100 may be configured to monitor one or more independent ground engaging elements coupled to the agricultural implement main frame and/or tool bar assemblies.

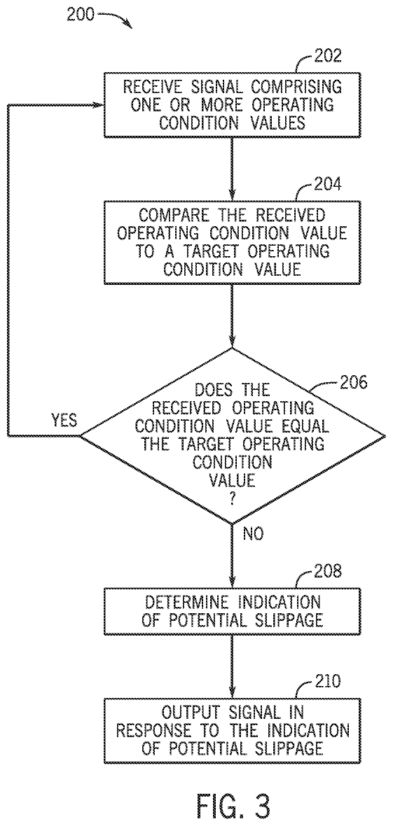

With the foregoing in mind, FIG. 3 is a flow diagram of an embodiment of a method 200 for determining an indication of potential slippage of the work vehicle based on detected operating conditions (e.g., input received from the one or more sensors). The following description of the method 200 is described as being performed by a processing system (e.g., the controller 56), but any suitable processor-based device or system may be specially programmed to perform the method described herein. Moreover, although the following description of the method 200 is described as including certain steps performed in a particular order, the steps of the method 200 may be performed in any suitable order, certain steps may be omitted, certain steps may be added and/or modified, or a combination thereof.

As represented by block 202, signal(s) indicative of one or more operating condition values may be received (e.g., by the controller). As discussed herein, the signal(s) indicative of one or more operating condition values may be received from the one or more sensors. Additionally or alternatively, signal(s) indicative of one or more operating condition values may be received via input from the user interface (e.g., from the operator).

Each operating condition value may be compared (e.g., by the controller), at block 204, to a respective target operating condition value or to a respective range of target operating condition values. As discussed herein, each target operating condition value/range of target operating condition values may be associated with a no-slip condition (e.g., a slip condition value below a threshold slip value) of the agricultural system (e.g., the agricultural implement, the work vehicle). Each target operating condition value and/or each range of target operating condition values may be stored (e.g., within the memory device) and retrieved by the controller.

At block 206, the controller may determine whether the operating condition value is substantially equal to (e.g., within a threshold difference of) the target operating condition value and/or whether the operating condition value is within the range of target operating condition values. If the controller determines that the operating condition value is substantially equal to (e.g., within a threshold difference of) the target operating condition value and/or the operating condition value is within the range of target operating condition values, the method may return to block 202. Thus, the controller may continue to receive signal(s) indicative of one or more operating condition values and compare each operating condition value to the respective target operating condition value and/or the range of target operating condition values to determine whether the operating condition value is substantially equal to the target operating condition value and/or within the range of target operating condition values. In this way, the controller may cyclically monitor the current operating conditions of the agricultural system (e.g., via the one or more sensors) to identify an indication of potential slippage of the work vehicle.

If the operating condition value is not substantially equal to the target operating condition value and/or within the range of target operating condition values, the controller, at block 208, identifies an indication of potential slippage of the work vehicle, and in response to identifying the indication of potential slippage, at block 210, the controller outputs a signal. As discussed herein, the signal may be a control signal configured to adjust (e.g., via the wheel assembly actuators, the hitch actuator, the tool bar actuators, the tool actuators, or a combination thereof) the engagement (e.g., penetration depth) of the ground engaging tools to decrease the draft load of the agricultural implement. Furthermore, in some embodiments, the signal may cause the indication to be displayed via the user interface. The displayed indication may notify an operator of the agricultural system of the potential slippage of the work vehicle. In some embodiments, the displayed indication may enable the operator to adjust via user input (e.g., via the user interface, a mechanical switch and/or lever) the engagement (e.g., penetration depth) of the ground engaging tools to decrease the draft load of the agricultural implement. In certain embodiments, the signal may additionally or alternatively control operation of the work vehicle, such as causing the work vehicle to change speed and/or to change directions.

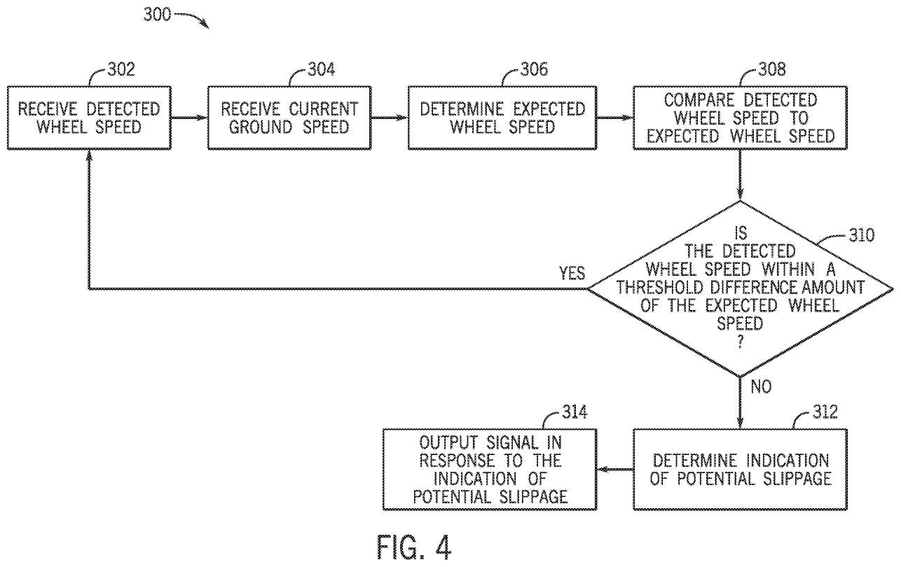

FIG. 4 is a flow diagram of an embodiment of a method 300 for determining the indication of potential slippage of a work vehicle based on comparing a detected speed of a rotational element of the agricultural implement to an expected speed of the rotational element of the agricultural implement. The following description of the method 300 is described as being performed by a processing system (e.g., the controller 56), but any suitable processor-based device or system may be specially programmed to perform the method described herein. Moreover, although the following description of the method 300 is described as including certain steps performed in a particular order, the steps of the method 300 may be performed in any suitable order, certain steps may be omitted, certain steps may be added and/or modified, or a combination thereof.

As represented by block 302, the controller may receive a signal indicative of a speed of a rotational element (e.g., wheel, track, gauge wheel, press wheel, etc.) of the agricultural implement. As discussed herein, a speed sensor (e.g., radar sensor, tachometer) may be associated with the rotational element and configured to output the signal indicative of the speed (e.g., rotational speed, linear speed) of the rotational element. Furthermore, the controller may be communicatively coupled to the speed sensor and configured to receive the signal indicative of the speed of the rotational element from the speed sensor.

At block 304, the controller may receive a signal indicative of a ground speed of the agricultural system (e.g., the agricultural implement and/or the work vehicle). As discussed herein, the ground speed of the agricultural system may be determined based on a transmission speed of the work vehicle. For example, a work vehicle controller may determine the ground speed based on the transmission speed and output a signal indicative of the ground speed of the work vehicle. Furthermore, the ground speed of the agricultural system may be determined via a radar sensor and/or a tachometer coupled to the work vehicle. In some embodiments, the agricultural system may include a spatial locating device communicatively coupled to the controller. The spatial locating device may be coupled to the agricultural implement or, in some embodiments, to the work vehicle. Further, the spatial locating device is configured to output a signal (e.g., positional data) indicative of a position (e.g. location) of the agricultural implement and/or the work vehicle. The spatial locating device may include any suitable system configured to measure and/or facilitate determination of the position of the agricultural implement and/or the work vehicle, such as a global positioning system (GPS) receiver, for example. The spatial locating device may output the signal (e.g., positional data) indicative of the position (e.g., location) of the agricultural implement and/or the work vehicle to the controller. Furthermore, the controller may receive the positional data and determine the current ground speed of the agricultural system based on the positional data. In some embodiments, the spatial locating device may output the detected ground speed of the agricultural system to the controller.

The controller may determine the expected speed (e.g., expected rotational rate/speed, expected linear speed) of each rotational element (e.g., wheel, gauge wheel, press wheel, track, etc.) of the agricultural implement, at block 306, based on the ground speed of the agricultural system. As discussed herein, in some embodiments, each rotational element may be a non-powered rotational element (e.g., non-powered wheel, non-powered disc) of the agricultural implement. In other words, the rotational element may be driven to rotate by contact with the surface of the soil in combination with a force (e.g., movement) of the agricultural implement and/or work vehicle driving the agricultural implement across the field, and not by a respective motor or engine.

Thus, the controller may receive or determine the ground speed of the agricultural system and determine the expected linear speed of each rotational element based on the ground speed. If the agricultural system is moving along a straight path, the expected linear speed of each rotational element may be equal to the ground speed of the agricultural system. However, if the agricultural system is moving along a curved path, the expected linear speed may be determined based on the ground speed of the agricultural system, a radius of curvature of the curved path, and a location of the rotational element on the agricultural implement. In some embodiments, the controller may determine the linear speed of a respective rotational element based on the rotational rate and the diameter of the rotational element. The diameter of each rotational element may be stored (e.g., within the memory device), such as in a lookup table, and associated with a respective rotational element on the agricultural implement. In some embodiments, the expected linear speed of at least one rotational element may be received by the controller via input from the user interface (e.g., from the operator). Additionally or alternatively, the expected linear speed associated with at least one rotational element may be established in some other way, such as by being pre-programmed into the controller by a manufacturer.

Moreover, the controller may determine the expected rotational rate (e.g., expected rotational speed) of each rotational element (e.g., wheel 60, gauge wheel, track 25) based on the ground speed of the agricultural system. For example, the controller may determine the ground speed of the agricultural system and determine the expected rotational rate of each rotational element based on the ground speed. If the agricultural system is moving along a straight path, the expected rotational rate of each rotational element may be determined based on the ground speed of the agricultural system and the diameter of the rotational element (e.g., perimeter of the rotational element). However, if the agricultural system is moving along a curved path, the expected rotational rate may be determined based on the ground speed of the agricultural system, the diameter of the rotational element, a radius of curvature of the curved path, and a location of the rotational element on the agricultural implement. As discussed herein, the diameter of each rotational element may be stored (e.g., within the memory device), such as in a lookup table, and associated with a respective rotational element on the agricultural implement. In some embodiments, the expected rotational rate of at least one rotational element may be received by the controller via input from the user interface (e.g., from the operator). Additionally or alternatively, the expected rotational rate associated with at least one rotational element may be established in some other way, such as by being pre-programmed into the controller by a manufacturer.

The detected speed (e.g., rotational rate/speed, linear speed) of the rotational element may be compared (e.g., by the controller), at block 308, to the expected speed (e.g., expected linear speed, expected rotational rate/speed) of the rotational element. At block 310, the controller may determine whether the detected speed of the rotational element is substantially equal to (e.g., within a threshold difference of) the expected speed of the rotational element. In some embodiments, the controller may determine whether the detected speed of the rotational element is within a range of expected speeds of the rotational element. If the controller determines that the detected speed is substantially equal to (e.g., within a threshold difference of, within the range of expected speeds) the expected speed, the method may return to block 302. Thus, the controller may continue to receive a signal indicative of the detected speed (e.g., linear speed, rotational rate/speed) of the rotational element, determine the ground speed, determine the expected speed (e.g., expected linear speed, expected rotational rate/speed) of the rotational element, and compare the detected speed of the rotational element to the expected speed of the rotational element. In this way, the controller may cyclically monitor the speed of the rotational element of the agricultural implement (e.g., via a respective sensor) to identify an indication of potential slippage of the work vehicle.

If the detected speed of the rotational element is not substantially equal to (e.g., not within a threshold difference of, not within the range of expected speeds) the expected speed of the rotational element, the controller, at block 312, identifies an indication of potential slippage of the work vehicle (e.g., slipping of the work vehicle wheel(s)/track(s)), and in response to identifying the indication of potential slippage, at block 314, the controller outputs a signal. As discussed herein, the signal may be a control signal configured to adjust (e.g., via the wheel assembly actuators, the hitch actuator, the tool bar actuators, the tool actuators, or a combination thereof) the engagement (e.g., penetration depth) of the ground engaging tools to decrease the draft load of the agricultural implement. Furthermore, in some embodiments, the signal may cause the indication to be displayed via the user interface. The displayed indication may notify an operator of the agricultural system of the potential slippage of the work vehicle. In some embodiments, the displayed indication may enable the operator to adjust via user input (e.g., via the user interface, a mechanical switch and/or lever) the engagement (e.g., penetration depth) of the ground engaging tools to decrease the draft load of the agricultural implement. In certain embodiments, the signal may additionally or alternatively control operation of the work vehicle, such as causing the work vehicle to change speed and/or to change directions.

The methods 200 and/or 300 discussed herein may be repeatedly or iteratively performed. For instance, after a signal is output to adjust the operation of the agricultural implement, such as to reduce engagement between a ground engagement tool and the soil, each operating condition value (e.g., the detected linear speed/rotational speed of the rotational element) may be received again for comparison to the respective target operating condition value and/or the respective range of target operating condition values (e.g., such as the expected linear/rotational speed of the rotational element). An additional operation may be performed based on the comparison between the operating condition value and the target operating condition value and/or the range of operating condition values. As an example, an additional signal (e.g., control signal) may be output to further reduce engagement between the ground engagement tool(s) and the soil (e.g., reduce penetration depth) to further reduce the draft load of the agricultural implement. Thus, the operation of the agricultural implement may continue to be adjusted to reduce the potential of causing slippage of the work vehicle, such as until each operating condition value is determined to be substantially equal to the target operating condition value and/or within the range of target operating condition values.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. An agricultural system, comprising:
an agricultural implement comprising a plurality of ground engagement tools, wherein each ground engagement tool of the plurality of ground engagement tools is configured to engage soil of a field; and
a controller, comprising a memory and a processor, wherein the controller is configured to:
receive a signal indicative of a speed of a rotational element of the agricultural implement;
determine that a difference between the speed of the rotational element and an expected speed of the rotational element of the agricultural implement is greater than a threshold, wherein the expected speed of the rotational element is associated with a no-slip operating condition of the agricultural implement; and
in response to the difference being greater than the threshold, reduce an engagement between at least one ground engagement tool of the plurality of ground engagement tools and the soil, output an output signal, or a combination thereof.

2. The agricultural system of claim 1, comprising a sensor communicatively coupled to the controller, wherein the sensor is configured to output the signal indicative of the speed of the rotational element.

3. The agricultural system of claim 2, wherein the sensor comprises an optical sensor, a reflectivity sensor, an electrical conductivity sensor, a radar sensor, a tachometer, an inclinometer, an accelerometer, a gyroscope, or any combination thereof.

4. The agricultural system of claim 1, comprising a spatial locating device communicatively coupled to the controller and configure to output positional information of the agricultural implement, wherein the controller is configured to receive the positional information and to determine a ground speed of the agricultural implement based on the positional information.

5. The agricultural system of claim 4, wherein the controller is configured to determine the expected speed of the rotational element based on the ground speed, and compare the speed of the rotational element to the expected speed of the rotational element to determine the difference.

6. The agricultural system of claim 5, comprising a work vehicle coupled to the agricultural implement, wherein the controller is configured to identify an indication of potential slippage of the work vehicle when the difference is greater than the threshold.

7. The agricultural system of claim 6, comprising an output device communicatively coupled to the controller and configured to receive the output signal, wherein the output signal comprises the indication of potential slippage of the work vehicle.

8. The agricultural system of claim 7, wherein the output device comprises an indicator light, a speaker, a display, or any combination thereof, and the output device is configured to present the indication of potential slippage of the work vehicle.

9. The agricultural system of claim 8, wherein the speed of the rotational element comprises a rotational rate of the rotational element or a linear speed of the rotational element.

10. The agricultural system of claim 1, wherein the speed of the rotational element comprises a rotational rate of the rotational element or a linear speed of the rotational element.

11. The agricultural system of claim 1, wherein the rotational element comprises a wheel of the agricultural implement, a track of the rotational element, or a disc of the agricultural implement.

12. A method of controlling engagement between at least one ground engagement tool of a plurality of ground engagement tools of an agricultural implement, wherein the at least one ground engagement tool is configured to engage soil of a field, comprising:
receiving, via a processor, a signal indicative of a speed of a rotational element of the agricultural implement;
determining, via the processor, that a difference between the speed of the rotational element and an expected speed of the rotational element of the agricultural implement is greater than a threshold, wherein the expected speed of the rotational element is associated with a no-slip operating condition of the agricultural implement; and
in response to the difference being greater than the threshold, reducing an engagement between the at least one ground engagement tool and the soil, outputting an output signal, or a combination thereof.

13. The method of claim 12, wherein a sensor is communicatively coupled to the processor and configured to output the signal indicative of the speed of the rotational element, wherein the sensor comprises a optical sensor, a reflectivity sensor, an electrical conductivity sensor, a radar sensor, a tachometer, an inclinometer, an accelerometer, a gyroschope, or any combination thereof.

14. The method of claim 12, comprising:
receiving, via the processor, positional information associated with the agricultural implement, wherein the positional information is outputted by a spatial locating device communicatively coupled to the processor; and
determining, via the processor, a ground speed of the agricultural implement based on the positional information.

15. The method of claim 14, comprising:
determining, via the processor, the expected speed of the rotational element based on the ground speed; and
comparing, via the processor, the speed of the rotational element to the expected speed of the rotational element to determine the difference.

16. The method of claim 15, wherein the agricultural implement is coupled to a work vehicle, and comprising:
identifying, via the processor, an indication of potential slippage of the work vehicle when the difference is greater than the threshold; and
transmitting, via the processor, the output signal to an output device, wherein the output signal is configured to cause the output device to display the indication of potential slippage of the work vehicle.

17. An agricultural system, comprising:
a work vehicle;
an agricultural implement coupled to the work vehicle and comprising a plurality of ground engagement tools, wherein each ground engagement tool of the plurality of ground engagement tools is configured to engage soil of a field;
a controller, comprising a memory and a processor; wherein the controller is configured to:
receive a signal indicative of a speed of a rotational element of the agricultural implement;
determine that a difference between the speed of the rotational element and an expected speed of the rotational element of the agricultural implement is greater than a threshold, wherein the expected speed of the rotational element is associated with a no-slip operating condition of the agricultural implement; and
in response to the difference being greater than the threshold, reduce an engagement between at least one ground engagement tool of the plurality of ground engagement tools and the soil, output an output signal, or a combination thereof.

18. The agricultural system of claim 17, comprising a sensor communicatively coupled to the controller, wherein the sensor is configured to output the signal indicative of the speed of the rotational element.

19. The agricultural system of claim 17, comprising a spatial locating device communicatively coupled to the controller and configure to output positional information of the agricultural implement, wherein the controller is configured to receive the positional information and to determine a ground speed of the agricultural implement based on the positional information.

20. The agricultural system of claim 19, comprising a work vehicle coupled to the agricultural implement, wherein the controller is configured to:
determine the expected speed of the rotational element based on the ground speed;
compare the speed of the rotational element to the expected speed of the rotational element to determine the difference; and
identify an indication of potential slippage of the work vehicle when the difference is greater than the threshold.
